(19) United States
(12) Patent Application Publication
(10) Pub. No.: US 2016/0037772 A1
(43) Pub. Date: Feb. 11, 2016

(54) INCREASING ABIOTIC STRESS TOLERANCE IN PLANTS

(71) Applicant: Mario Miguel Guerrero Mendez, Talca (CL)

(72) Inventor: Mario Miguel Guerrero Mendez, Talca (CL)

(21) Appl. No.: 14/579,217

(22) Filed: Dec. 22, 2014

(30) Foreign Application Priority Data
Aug. 8, 2014 (CL) 201402206

(51) Int. Cl. A01N 37/42; A01N 37/06

(52) U.S. Cl. CPC A01N 37/42; A01N 37/06

(57) ABSTRACT

Methods for treating a plant comprise contacting a plant or a part of a plant with one or more of 9-oxononanoic acid, arachidonic acid, or a salt or ester thereof; wherein the amount is effective to increase tolerance to abiotic stress in the plant or to reduce a consequence of abiotic stress in the plant. Additional ingredients can be included such as dicarboxylic acids, pipecolic acid, or salicylic acid, or salts/esters thereof; sunblocks such as kaolin or calcium carbonate; carriers such as inert powders or liquids; and co-treatment materials such as fertilizers, plant nutrients, biostimulants, micronutrients, amino acids, plant hormones, pesticides, fungicides, insecticides, nematicide, stearic acid, vegetable oil, or phospholipid.

### CROSS-REFERENCE TO RELATED APPLICATION

This application claims priority from the Chilean Patent Application No. 201402206, filed Aug. 8, 2014, which is incorporated by reference herein in its entirety.

### FIELD OF THE INVENTION

This invention relates to agrochemical compositions and methods related to abiotic stress tolerance in plants.

### BACKGROUND OF THE INVENTION

Abiotic stress affects negatively the growth and development of plants and leads to significant reductions in crop yield and quality. Abiotic stress includes excessive or insufficient light intensity, cold temperatures and freezing, drought, salinity, presence of toxic metals, nutrient-poor soils, (Conrath, U., “Priming of Induced Plant Defense Responses,” Adv Bot. Res., 51, 361-95, 2009). The plants are often subjected to a combination of stresses; for example, drought conditions often combined with excessive heat. Contrary to the response of a plant to drought, the response of a plant to heat is to open the stomatal opening, in order to cool the leaves by transpiration. This conflict in the response reduces the capacity of plants to respond to heat stress.

Methods have been developed to alleviate the abiotic stress in plants, and many methods are commercially available, for example, shading nets, reflective films and metallized plastic foil materials. Furthermore, the surface temperature of the plant can be reduced by applying low volumes of water, cooling the fruit through evaporative cooling of the surrounding air. An additional method to relieve heat stress includes the use of technologies comprising particulate films: commercial products such as RAYNOX™ SURROUND™, SCREEN DUO™ and SUNCROPS™ are available but have important limitations and may provide uneven performance.

### SUMMARY OF THE INVENTION

Embodiments of the present invention provide compositions and methods to increase abiotic stress tolerance and/or reduce the consequences of abiotic stress in a plant or part thereof. Accordingly, disclosed are compositions for use in agriculture, comprising a first agent and a second agent, wherein the first agent comprises one or more of 9-oxo-nonanoic acid, arachidonic acid, or salts or esters thereof, and wherein the second agent is operable as a sunblock. In some embodiments, the composition is in powder form. In some embodiments, the composition is in liquid form. In some embodiments, the first agent is present in the composition in an amount between 0.1 g/kg and 999.9 g/kg and the second agent is present in the composition in an amount between 0.1 g/kg and 999.9 g/kg. The second agent is not particularly limited, and can be selected from one or more of silica, silica gels, silicates, talc, kaolin, limestone, lime, chalk, clay, bentonite, calcite, corn starch powder, dolomite, diatomaceous earth, calcium sulphate, magnesium sulfate, magnesium oxide, ground plastics, resins, and waxes, products of vegetable origin, such as cereal flour, tree bark meal, wood meal and nutshell meal, or cellulose powder. The compositions can further comprise liquid or solid carriers, surfactants and dispersants.

In some embodiments, the composition further comprises a third agent, wherein the third agent comprises one or more of a fertilizer, a dicarboxylic acid, bio stimulant, plant nutrient, plant micronutrient, amino acid, plant hormones and hormone-like compound, pesticide, fungicide, insecticide, nematicide, stearic acid, vegetable oil, or phospholipid. Plant hormones typically include auxins, cytokinins, abscisic acid, gibberellin, ethylene, or salicylic acid. Biostimulants typically include glycine betaine, aminobutyric acid, or seaweed extract. In some embodiments, the third agent comprises pipecolic acid. In some embodiments, the composition comprises kaolin and one or more of 9-oxononanoic acid, arachidonic acid, or salts or esters thereof, and further comprises one or more of salicylic acid or pipecolic acid. In some embodiments, the composition comprises 9-oxononanoic acid or salts or esters thereof, one or more of kaolin or calcium carbonate, and further comprises glycine betaine and salicylic acid.

Also disclosed are methods for treating a plant comprising contacting a plant or a part of a plant with a first agent, the first agent comprising one or more of 9-oxononanoic acid, arachidonic acid, or a salt or ester thereof, wherein the amount of the first agent is effective to increase tolerance to abiotic stress on the plant or to reduce a consequence of abiotic stress on the plant. In some embodiments, the methods further comprise contacting the plant or the part of a plant with a second agent, wherein the second agent is operable as a sunblock. The second agent is not particularly limited, and can be selected from one or more of silica, silica gels, silicates, talc, kaolin, limestone, lime, chalk, clay, bentonite, calcite, corn starch powder, dolomite, diatomaceous earth, calcium sulphate, magnesium sulfate, magnesium oxide, ground plastics, resins, and waxes, products of vegetable origin, such as cereal flour, tree bark meal, wood meal and nutshell meal, or cellulose powder. In some embodiments, the second agent comprises kaolin or calcium carbonate or a combination thereof.

In some embodiments, the first agent further comprises pipecolic acid or salicylic acid or combination thereof. In some embodiments, the methods further comprise contacting the plant or the part of a plant with a third agent, wherein the third agent comprises one or more of a fertilizer, plant nutrient, biostimulant, micronutrient, amino acid, plant hormone, pesticide, fungicide, insecticide, nematicide, stearic acid, vegetable oil, or phospholipid.

The method of contacting the plant is not particularly limited, and includes spraying, dusting, sprinkling, scattering, fogging, dipping, injecting in the soil, soil incorporation, pouring, coating, seed treatment, soil treatment, and any combination thereof. A wide variety of plants are included in the disclosed methods. In some embodiments, the plant comprises a herbaceous plant, a horticultural plant, plants grown in forestry, a nursery plant, an ornamental plant, plants grown in the production of biofuels or edible oils, or any combination thereof. In some embodiments, the plant comprises apple, tomato, pear, pepper, green beans, dry bean, pumpkin, cucumber, melon, watermelon, melon, papaya, mango, pineapple, avocado, plum, cherry, peach, apricot, nectarine, grape, strawberry, raspberry, blueberry, mango, gooseberry, banana, fig, clementine, kumquat, orange, grapefruit, mandarin, tangerine, lemon, lime, hazelnut, pistachio nut, macadamia nuts, almonds, pecans, litchi, soybeans, corn, sugar cane, peanuts, cotton, canola oil, rapeseed, alfalfa, snuff, tomato, sugar beet, potatoes, peas, carrots, wheat, rice, barley, rye, sorghum, oats, triticale, quinoa, sunflower, lettuce, roses, tulips, violets, basil, oil palm, elm, ash, oak, maple, spruce, fir, cedar, pine, birch, cypress, coffee, or any combination thereof.

The methods are useful in a variety of abiotic stress conditions. In some embodiments, the abiotic stress comprises low temperatures, freezing, heat, high temperatures, drought, salinity, high intensity light, ozone or any combination thereof. In some embodiments, the abiotic stress comprises high temperature and high light intensity, high light intensity and drought, high temperature and drought, cold temperatures and low light intensity, or cold temperatures and high light intensity. In some embodiments, the consequence of the abiotic stress comprises sunburn damage, reduced fruit size, reduced cell division, reduced cell expansion, decreased yield of commercial fruit, reduced quality of appearance and texture of plant products, a reduction of the sugar content of the plant products, or any combination thereof. In some embodiments, the abiotic stress comprises high temperature and high light intensity, and the consequence of the abiotic stress comprises sunburn damage. In some embodiments, the abiotic stress comprises high temperature and high light intensity, and the consequence of the abiotic stress comprises the reduction of the sugar content of a part of the plant. In some embodiments, the abiotic stress comprises high temperature and high light intensity, and the consequence of the abiotic stress comprises a decrease in the yield of a part of the plant. In some embodiments, the abiotic stress comprises high temperature and high light intensity, and the consequence of the abiotic stress comprises a decrease in the size of a fruit of the plant.

The effective amount of the first agent is an amount between about 0.00001 and about 1000 g/ha. In some embodiments, the effective amount the first agent is an amount between about 1 and about 25 g/ha. In some embodiments, the frequency of the contacting is between about one time per month and about one time per day.

### DETAILED DESCRIPTION OF THE INVENTION

Before the present invention is described in detail, it is to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference “plant” includes two or more set of plants.

As used herein, “and/or” refers to and encompasses any and all possible combinations of one or more of the associated listed items as well as the lack of combinations when interpreted in the alternative form.

The term “about” as used herein, refers to a measurable value such as an amount of a compound or agent, dose, time or temperature, and typically encompasses a variation of ±10 of the specified amount.

The term as used herein “abiotic stress” refers to non-living factors that can cause damage to plants. As used herein, abiotic stress includes, but is not limited to, cold temperature that results in freezing, refrigeration, heat or high temperatures, drought, high light intensity, low light intensity, salinity, ozone, and/or combinations thereof. Indicators for abiotic stress factors are specific to each species and plant variety, and therefore vary widely according to species and plant varieties exposed to abiotic stress. This means that while one species may be severely affected by high temperature of 23° C., another species can only be impacted by the presence of temperatures around 30° C. Above 30° C. temperatures result in dramatic reductions in yields of most crops in temperate zones.

The terms “reduce” or “reduced” and other grammatical variations, as used herein, means diminished, decreased, for example, decreasing the size of the plant as a response to the impact abiotic stress.

The term “increased” or “increase” and other grammatical variations as used herein, means an improvement or increment, for example, increasing the number of fruits produced by a plant in response to abiotic stress relief to which the plant is exposed.

The term “effective” amount as used herein, is an amount of a compound or composition that is sufficient to achieve the desired effect, for example, to increase tolerance to abiotic stress in a plant or part of a plant and/or reduce the effect or consequences in the plant or part of the plant of the abiotic stress. The effective amount will vary with the type of plant or crop, the age and general condition of the plant or crop, the severity of abiotic stress conditions, the duration of abiotic stress conditions, the method and frequency of application of the composition, the agriculturally acceptable carrier-vehicle used in the specific composition used, and other similar factors within the knowledge and skill of those ordinary skill in the art. An “effective amount” in any individual case may be determined by one of ordinary skill in the art, referenced texts, relevant literature and/or by routine experimentation. As mentioned herein, an effective amount may comprise one or more applications and/or doses of the disclosed compositions to achieve the desired tolerance to abiotic stress increase and/or the desired reduction in the effect or consequences of abiotic stress.

An “enhanced tolerance to abiotic stress”, as used herein, refers to the ability of a plant or a part of a plant, exposed to abiotic stress and contacted with the compositions of the present invention, as described above, to withstand abiotic stress better than a control plant or a part of a plant. (i.e., a plant or a part of a plant that has been exposed to abiotic stress, but has not been contacted with the compositions of the present invention).

An “increased tolerance to abiotic stress” can be measured using a variety of variables. In some embodiments, the increased tolerance will be measured by an increase in the number and size of the fruit, the level or amount of cell division, the amount of damage from sunburn, crop yield, and so forth. In other embodiments, the increased tolerance will be measured as a reduction of sunburn compared to a plant or part of a plant exposed to the same condition, but not in contact with said composition.

“A consequence of abiotic stress” or a “result of the abiotic stress,” as used herein, refers to the effects, results or result of exposure of a plant or part of a plant to one or more (i.e. one, two, three, four, five, etc.) abiotic stress conditions. Consequences of abiotic stress include but are not limited to, sunburn damage, reduction in the number of plants or parts of a plant, reduction in the final product quality (e.g., fruit quality), measured by indicators such as color or shape. Some examples of indicators are: reduction in product quality due to poor appearance and texture, reduction in the size of the plants or parts of the plants, a reduction in cell division and so forth. Therefore, the consequences of abiotic stress are typically those consequences that negatively impact crop yield and quality.

“Reducing the results of abiotic stress” or “reducing the consequences of abiotic stress” as used herein; refers to the ability of a plant or a plant part exposed to abiotic stress to decrease or reduce the result of abiotic stress when the plant or the part of the plant is in contact with the compositions of the present invention, as described above, more efficiently than a control plant (i.e., a plant or a part of a plant that has been exposed to abiotic stress, but has not been contacted with the compositions of the present invention).

The term “sunblock” as used herein refers to a material which reflects or blocks a portion of incident solar radiation. Typical sunblocks are powders which when adhering to the surface being protected (for example, the surface of a fruit), reduce overheating and/or damage due to excessive solar radiation.

The term “carrier” as used herein refers to an inactive ingredient in a mixture which serves to increase the volume to facilitate application of one or more active ingredients. Carriers can be liquids such as water or inert powders. In some instances, carriers can also function as sunblocks.

The term “contacting” as used herein comprises any method in which a plant is exposed to, provided with, or in which a compound is applied to a plant or part thereof. Non-limiting examples of contacting include spraying, dusting, sprinkling, scattering, fogging, spraying, soaking, soil injection, soil incorporation, soaking (for example, treatment of ground), pouring, coating, infiltration of leaves or stems, seed treatment and the like, and/or combinations thereof. These and other contacting methods are well-known to those skilled in the art.

In plants, reactive oxygen species (“ROS”) are produced in various cell compartments, principally in chloroplasts and mitochondria, through electron transport chains to O₂. The chloroplasts are the principle sources of ROS in the photo-system. Mitochondrial respiration also produces significant quantities. In the apoplast, the activity of oxidases and peroxidases are the principle sources of free radicals, whereas in the peroxisomes, photo respiration generates H₂O₂ (Halliwell, B., “Reactive Species and Antioxidants. Redox Biology is a Fundamental Theme of Aerobic Life,” Plant Physiol., 141, 312-22, 2006).

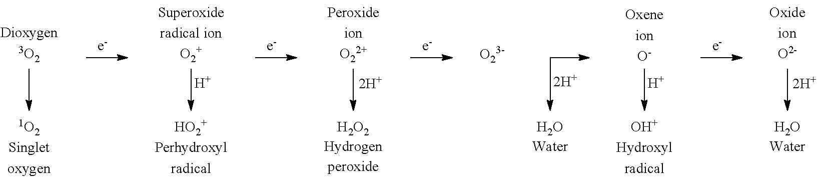

In photosynthesis, singlet oxygen can be produced from chlorophyll molecules as light scavengers. One of the functions of carotenoids in photosynthetic systems is to prevent damage caused by oxygen singlets, to eliminate excess light energy from chlorophyll molecules, or to extinguish oxygen singlets directly. In addition, the oxidizing species affect DNA, proteins, lipids, etc., reacting with double bonds in precursors such as polyunsaturated fatty acids (PUFA) such as (linoleic acid (18:2) and linolenic acid (18:3) and derivatives, known as lipid peroxidation (“LPO”).

Under conditions of stress, a process that occurs in the membranes that exacerbates the conditions of oxidative stress through the production of radicals derived from lipids that include lipids, alkaloid radicals, alkanes, and alcohols, and leads to the production of jasmonic acid, a precursor to one of the pathways that signal conditions of stress. The effects of the LPO is the reduction of membrane fluidity allowing entrance of molecules that normally do not cross the membrane, and finally causing damage by inactivating receptors, enzymes, and ion channels. Studies have shown this process occurs under conditions of drought or water stress, or salinity or salt stress (Pan et al., “Water-stress and N-nutrition effects on photosynthesis and growth of Brassica carinata,” Photosynthetica 49, 309-15, 2011), and under conditions of high UV light (radiation stress) (Gill, S. S. et al., “Reactive oxygen species and antioxidant machinery in abiotic stress tolerance in crop plants,” Plant Physiol. and Biochem., 48, 909-30, 2010).

The photosynthesis reactions in the chloroplasts are a continual source of ROS. Different ROS are produced in the interior of the plastids as products of photosynthesis. Superoxide dismutase (O₂⁻) converts to H₂O₂ by superoxide-dismutase (SOD) associated with the choroplast. Singlet oxygen is produced in PSII by the transfer of energy from excited molecules of chlorophyll oxygen. The flow of electrons is unbalanced due to the high production of biotic stress by light radiation, favoring the production of oxygen singlets inside the plastids.

The production of ROS in the chloroplasts leads to dramatic changes in nuclear gene expression including genes that encode for the detection of biotic and abiotic stress, inducing a signal cascade that activates ion channels like kinase cascades, and the accumulation of hormones such as salicylic acid, ethylene, jasmonic acid and abscisic acid. These simultaneous signals induce the expression of specific subsets of defense genes that lead to a general defense reaction.

LPO have been identified as metabolites that function as stress signals in the presence of stress conditions. 9-Oxononanoic acid (“ONA”) is a product of the LPO of linolenic acid when plants are under abiotic stress. Azalaic acid is another product of LPO. Pipecolic acid, a metabolite of lysine, is a non-proteinogenic amino acid that can induce the synthesis and buildup of salicylic acid, a plant defense signal.

Arachidonic acid (“AA”) is an essential fatty acid and a constituent of the membranes of plant cells. It is the precursor in the production of eicosanoid mediators in the central nervous system and immune response in mammals; in plants it is a mediator that allows the formation of different lipids with different biological activities through lipoxidation. AA is a precursor of several immune system molecules that allow a plant to attack pathogens.

ONA has been studied for the induction of pathogen resistance (biotic stress as opposed to abiotic stress) in plants grown at different concentrations sprayed on foliage. Further, neither its activity alone nor its activity mixed with kaolin has been studied. Furthermore, kaolin in agricultural uses is an excellent carrier and is compatible in spray tanks with most pesticides and soluble fertilizers used commercially. Kaolin is widely used in crops, for example, for citrus, horticulture, fruit, vegetables, avocados for control of sunburn.

Recent studies have shown that AA and ONA exhibit important properties of induction of resistance to pathogens, reduction of biotic stress, growth stimulation, and plant development. Until now these compositions have not been combined with kaolins at low concentration in a powder product.

Furthermore, prior art kaolin products used to prevent abiotic stress must be used in high volume and require high dosage per hectare, due to its large particle size. These products leave significant deposits on the fruit at the calyx end and pedicle; these deposits create difficulties in exporting the fruit. Further, residues and heavy metals are a risk to the end-users of the final fresh or processed fruit.

The methods and compositions disclosed in the present application can reduce plant damage and/or enhance stress tolerance in the presence of abiotic stress conditions.

Embodiments of this invention disclose compositions and methods to treat plants or parts of plants with an effective amount of a composition for reducing plant damage and/or enhancing stress tolerance in the presence of abiotic stress conditions. In some embodiments, the method comprises contacting the plant or a part thereof with a composition comprising an effective amount of ONA. In other embodiments the method disclosed comprises contacting the plant or a part thereof with a composition comprising an effective amount of AA. In some other embodiments the method disclosed comprises contacting the plant or a part thereof with a composition comprising an effective amount of ONA and AA. In some embodiments the method comprises contacting the plant or a part thereof with a composition comprising an effective amount of ONA and pipecolic acid. In some other embodiments the method comprises contacting the plant or a part thereof with a composition comprising an effective amount of AA and pipecolic acid. In some embodiments the method comprises contacting the plant or a part thereof with a composition comprising an effective amount of ONA, AA and pipecolic acid.

In some embodiments, a method is provided for increasing abiotic stress tolerance and/or reducing the result of abiotic stress in a plant or part thereof which comprises contacting a plant or part thereof with a composition comprising an effective amount of a derivative of ONA. A derivative, is for example, a salt or an ester of ONA. Suitable esters will be known to those of ordinary skill in the art, and are typically formed from C₁₋₁₂ alcohols, which can be saturated, unsaturated, branched, unbranched or cyclic. Suitable salts are those which are nontoxic to plants, and are otherwise not particularly limited.

Accordingly, in some embodiments, the method comprises contacting the plant or a part thereof with a composition comprising an effective amount of an ester of ONA. In some embodiments the method disclosed comprises contacting the plant or a part thereof with a composition comprising an effective amount of a salt of ONA. In other embodiments the method disclosed comprises contacting the plant or a part thereof with a composition comprising an effective amount of an ester of ONA and an ester of AA. In some other embodiments the method disclosed comprises contacting the plant or a part thereof with a composition comprising an effective amount of a salt of ONA and a salt of AA. In other embodiments the method disclosed comprises contacting the plant or a part thereof with a composition comprising an effective amount of an ester of ONA and pipecolic acid. In some embodiments the method disclosed comprises contacting the plant or a part thereof with a composition comprising an effective amount of a salt of ONA and pipecolic acid. In some other embodiments the method disclosed comprises contacting the plant or a part thereof with a composition comprising an effective amount of an ester of ONA, an ester of AA and pipecolic acid. In some embodiments the method disclosed comprises contacting the plant or a part thereof with a composition comprising an effective amount of a salt of ONA, a salt of AA and pipecolic acid. This list of embodiments is not meant to be exhaustive, and one skilled in the art will recognize that any permutation of ONA, AA and salts and esters thereof is encompassed in various embodiments of the present invention.

Methods disclosed increase the abiotic stress tolerance and/or reduce the effects of abiotic stress on a plant or part thereof compared to a control plant or part thereof exposed to the same abiotic stress, but without contact with the compositions of the present invention.

The consequences of abiotic stress can be measured using a variety of specific metrics including, but not limited to, the size and number of plants or plant parts (for example, the number and size of the fruit, the level or amount of cell division, the amount of fruit drop or abortion), the amount of damage by sunburn or any combination thereof. Reducing the effects of abiotic stress can also mean maintaining the size and number of plants or plant parts, or maintaining a level of damage. For example, fruit color, finish and/or shape can be compared to that observed in a control plant that has not been exposed to abiotic stress. In some embodiments, a method is provided for reducing the amount of flower abortion in a plant or a part of a plant exposed to abiotic stress which comprises contacting the plant or part of the plant with compositions of the present invention, as described above, compared to a control plant, exposed to the same conditions of abiotic stress, but not treated with said composition.

In some embodiments, the consequences of abiotic stress relate to damage from sunburn. Thus, in some embodiments, a method is provided for reducing damage from sunburn in a plant or a plant part comprising contacting a plant or a plant part with an effective amount of one or more of the compositions of the present invention, thus reducing the amount of sunburn damage compared to a control plant or part of a plant exposed to the same condition of abiotic stress, but not treated with said composition. In some embodiments, the abiotic stress corresponds to conditions of high temperature and high light intensity; being the result of this combination of abiotic stress.

In some embodiments, the consequence of abiotic stress is reduced fruit size. Therefore, in some embodiments a method is provided to decrease the reduction in fruit size in a plant or part thereof comprising contacting a plant or part thereof with a composition disclosed in the present invention, so as to decrease the reduction of fruit size compared to a control plant, or part thereof, exposed the same stress condition, but not treated with said composition.

As discussed above, abiotic stress includes but is not limited to, low temperature cold, freezing, heat, or high temperature, drought, high light intensity, salinity, ozone, and/or combinations thereof. In some particular aspects of the present invention, the abiotic stress is freezing. In other aspects of the invention, the abiotic stress is chilling. In other aspects of the invention, the abiotic stress is high light intensity. In other aspects of the invention, the abiotic stress is high temperature. Those skilled in the art will understand that a plant may be exposed to one or more abiotic stresses (Mittler, R., “Abiotic stress, the field environment and stress combination,” Trends Plant Sci. 11(1), 15-19, 2006). Therefore, in some embodiments, the term abiotic stress refers to a combination of abiotic stress factors. Combinations of such stress conditions include, but not high light intensity and high temperature limited to; drought, salinity; high temperature and salinity; drought and high temperatures; to high light intensity and cold temperature; to high light intensity, high temperature and drought; high light intensity in combination with high temperature and salinity, and the like. Thus, in some embodiments, the combination of abiotic stress can be high temperature and high light intensity. In other embodiments, the combination of abiotic stress can be high temperature, high light intensity and drought. In other embodiments, the combination of abiotic stress is drought and high temperature. In other embodiments, the combination of abiotic stress can be high light intensity and cold, and the like.

A plant or part thereof which is exposed to a high temperature in combination with high light intensity may suffer sunburn. The damage from sunburn is a major problem in the fruit industry and results in losses of millions of euros. (Yuri, J. A., et al., “Evaluation of the 2008/2009 Season,” Pomáceas Technical Bulletin, 9(3), May 2009). There are three types of sunburn on the fruit that have been identified in apples. The first type is a necrotic spot in fruit, on the side exposed to the sun, resulting in the death of skin cells when the temperature of the surface of the fruit reaches about 50° C. High temperature alone is sufficient to induce this condition. The second type is called “browning by sunburn” and results in a yellow, bronze or brown stain on fruit exposed to the sun. This type of damage occurs in the parts of the surface of the fruit where the temperature reaches at least about 45° C. and requires the presence of sunlight. The threshold temperature required for tanning burn depends on the crop. The third type of sunburn damage occurs in the fruit that is suddenly exposed to sunlight; for example, after clearing tree branches or moving a branch with increasing load of fruit or after the harvest of the apples while they stay in bins in the sun. Such sunburn is caused by light and relatively low ambient temperatures, for example, about 20° C. with the surface temperature of fruit around 30° C. Heat stress can also induce or increase damage to the surface of the fruit and/or disorders of fruits, including markings (dark spots), lenticel breakdown, scalding from sunburn (sunscald), cracking/splitting, misshapen fruit, bitter pit (spots) and water core. Damaged fruit and/or sunburn can also serve as entry points for fungi and other pathogens (Jung et al., “Systemic Priming in Plant Immunity,” Science, 324:5923, 89-91, 2009).

Therefore, in some embodiments, methods are provided for increasing the heat tolerance in a plant or part thereof comprising contacting a plant or part thereof with a composition of the present invention; thereby increasing the tolerance of the plant or portion thereof to high temperatures and thus reduce damage sunburn compared to a control, i.e., a plant or part thereof exposed to the same abiotic stress (for example, high temperatures), but not treated with the compositions of the present invention. In other embodiments, a method is provided to increase the tolerance to high temperature and high light intensity in a plant or part thereof comprising contacting the plant or part thereof with a composition of the present invention, thereby increasing the tolerance to high temperature, high light intensity and the consequent reduction of sunburn damage in compared to a control. In other embodiments, a method is provided to increase the tolerance to high temperature, high light intensity and drought in a plant or part thereof comprising contacting the plant or plant part thereof with a composition of the present invention, thereby increasing the tolerance of the plant or portion thereof to high temperatures, high light intensity and drought as compared to a control. In further embodiments, a method is provided to increase the tolerance to high temperatures and drought in a plant or part thereof comprising contacting the plant or part thereof with a composition comprising an effective amount of one or more of ONA, AA, or derivative thereof, thus increasing tolerance to high temperatures and drought compared to a control. In other embodiments, a method is provided to increase the tolerance to high light intensity and drought in a plant or part thereof comprising contacting the plant or part thereof with a composition comprising an effective amount of ONA or derivative thereof, thereby increasing the tolerance to high light intensity and drought as compared to a control. In other embodiments, a method is provided for increasing drought tolerance in a plant or part thereof comprising contacting the plant or part thereof with a composition comprising an effective amount ONA or derivative thereof, thus increasing drought tolerance compared to a control.

Abiotic stress such as high temperatures can result in crop losses due to the dropping of immature fruit. Therefore, in some embodiments, a method is provided to increase the tolerance to high temperatures in a plant or part thereof and comprises contacting the plant or part thereof with a composition comprising a effective amount of ONA or derivatives thereof, thereby increasing the tolerance of the plant or portion thereof to high temperature and obtaining reducing fruit drop compared to a control, i.e., a plant or part of the same that has been exposed to the same conditions of abiotic stress, but have not been contacted with the compositions of the present invention comprising ONA or derivatives thereof.

Cell division and cell expansion (fruit size) is affected by abiotic stresses including high temperature, high light intensity and/or drought. Each of these factors of abiotic stress, alone or in combination, can result in reduction of cell division and cell expansion and cause subsequent shrinking of the fruit. Therefore, in some embodiments, the present invention provides methods for increasing the tolerance to high temperatures and/or high light intensity and/or drought in a plant or part thereof comprising contacting the plant or plant part thereof with a composition comprising an effective amount of a ONA or derivative thereof, thereby increasing the tolerance of the plant or portion thereof to high temperatures and/or high light intensity and/or drought, with maintenance of cell division and expansion; maintaining or increasing the size of the fruit compared to a control. Particularly, embodiments of the present invention provide methods for increasing the heat tolerance in a plant or part thereof which comprises contacting the plant or part thereof with a composition comprising an effective amount of a ONA or derivatives thereof, thereby increasing the tolerance of the plant or part thereof at high temperatures, maintaining the division and cell expansion, maintaining or increasing fruit size compared to a control.

The number and size of the plants or parts thereof, the quality of the plant or part thereof which is obtained at harvest for example, fruit quality, are also affected by abiotic stress. Therefore, depending on the abiotic stress to the plant or plant part exposed, the size and/or number of plants or parts thereof can be reduced. The stress can for example reduce the size and/or quality of the fruit. Quality can be measured as color, finish, and/or shape; for example, reduced fruit quality due to poor appearance and texture.

Therefore, in some embodiments of the present invention, a method is provided for increasing abiotic stress tolerance in a plant or part thereof which comprises contacting the plant or part thereof with a composition comprising an effective amount of one or more of ONA, AA, or derivatives thereof, thereby increasing the tolerance of the plant or portion thereof to abiotic stress and maintaining the number and/or size of a plant or part thereof in comparison with a control. In other embodiments, the present invention provides a method of increasing abiotic stress tolerance in a plant or part thereof which comprises contacting the plant or part thereof with a composition comprising an effective amount of ONA, AA, or derivatives thereof, thereby increasing the tolerance of the plant or portion thereof to abiotic stress, maintaining the quality of a plant or part thereof in comparison with a control.

In some embodiments, the compositions further comprise a second agent that functions as a sunblock. The second agent may also function as a carrier vehicle or agriculturally-acceptable carrier. Agriculturally acceptable carriers or vehicles in the present invention may include natural or synthetic, organic or inorganic material, which is combined with the first agent to facilitate its application to the plant, or part thereof. Typically, the particle size for a sunblock is in the range of about 0.5 to 3 microns. A preferred carrier is kaolin and/or calcium carbonate, and is also operable as a sunblock. A vehicle carrier or agriculturally-acceptable carrier includes, but is not limited to, inert components, dispersants, surfactants, adjuvants, glue agents, adhesives, binders, or combinations thereof, that can be used in agricultural formulations. The agriculturally acceptable carrier-vehicles can be solid or liquid and are well known to those skilled in the art. Solid carriers include, but are not limited to, silica, silica gels, silicates, talc, kaolin, limestone, lime, chalk, clay, bentonite, calcite, corn starch powder, dolomite, diatomaceous earth, calcium sulphate, magnesium sulfate, magnesium oxide, ground plastics, resins, and waxes, all of which can provide the desired sunblock function. The second agent also includes products of vegetable origin; such as cereal flour, tree bark meal, wood meal and nutshell meal (for example, walnut shell powder), cellulose powder and so forth and combinations of all the above.

Non-limiting examples of liquid carriers include water, alcohols, ketones, glycerol, petroleum fractions, aromatic or paraffinic hydrocarbons, chlorinated hydrocarbons, liquefied gases; the like and combinations thereof. Therefore, the liquid carriers may include, but are not limited to, xylene, methylnaphthalene and the like, isopropanol, ethylene glycol and the like, may also include acetone, cyclo hexanone, and the like, vegetable oils such as soybean, olive, cottonseed, corn oils and the like in addition to their combinations.

In some embodiments, an agriculturally acceptable carrier in the present invention comprises a surface active agent (surfactant), which may be a wetting agent of ionic or nonionic emulsifier, or dispersant. Examples of surfactants suitable for use with the compositions of the present invention but not limiting, include benzene, alkyl sulfonates and alkyl naphthalene sulfonates, alkyl and aryl-alkyl, alkyl amine oxides, alkyl phosphate esters and aryl alkyl, organosilicones, organic wetting agents, alcohol ethoxylates, alkoxylated amines, sulfated fatty alcohols, amines or amides, esters of long chain acids, esters of sodium sulfosuccinate, sulfated fatty acid esters or sulfonated, petroleum sulfonates, sulfonated vegetable oils, ditertiary acetylenic glycols, copolymers and fatty acid esters.

Nonionic surfactants useful in the compositions of this invention include, but are not limited to, polyglycol ether derivatives of aliphatic or cycloaliphatic alcohols, saturated fatty acids and unsaturated or alkylphenols, which have 3 to 10 ether groups glycolic and 8 to 20 carbon atoms (aliphatic). Other non-limiting examples of suitable nonionic surfactants include castor oil derivatives and fatty acid esters.

Examples of useful dispersants for the compositions of the present invention include methyl cellulose, polyvinyl alcohol, sodium lignin sulfonates, calcium lignosulfonates. In further embodiments of this invention, the compositions disclosed in the invention may also comprise stabilizers such as magnesium aluminum silicate, gums and the like. Therefore, some embodiments of the invention, the compositions disclosed may be mixed with one or more agriculturally acceptable solid or liquid carrier-vehicles, prepared by various means, for example, made homogeneous mixtures; mixing and/or grinding the composition(s) using suitable carriers, known to those skilled in the art of conventional formulation.

The compositions of the invention may be formulated in any suitable formulation to be applied to or put a plant or part thereof in contact with the composition. Suitable formulations include, but are not limited to; an aerosol, a suspension, a powder, a granule, a foam, a paste, vegetable oil emulsions or mineral oil or water or oil/water, capsules, and combinations thereof.

The powders can be prepared by mixing or grinding the compound ONA, AA, or their derivatives; (active components) with a solid carrier-vehicle. Suitable powders have a particle size between about 0.5 and 3 microns. In another embodiment, the composition can be formulated as granules, the granules may include; coated, impregnated granules or homogeneous granules can be prepared by binding the active ingredient to a solid carrier granules. Other forms of formulation are solutions; solutions can be prepared by dissolving the active component in a liquid carrier (e.g., water), optionally including a surfactant.

In some embodiments, compositions can comprise a third agent. The third agent can comprise additional active compounds that are useful in combination with the first agent. These active compounds can include, but are not limited to, fertilizers, plant nutrients and plant micronutrients, amino acids, plant hormones and hormone-like compounds, and biostimulants. They may also include pesticides, fungicides, insecticides, nematicide, stearic acid, vegetable oil, or phospholipid besides reflecting and similar materials. Fertilizers can include ammonium, ammonium phosphate, ammonium nitrate, urea, and sulfate. Plant hormones and hormone-like compounds can include, but are not limited to auxins, cytokinins, abscisic acid, gibberellins, ethylene, salicylic acid, and the like; and combinations thereof. For example, salicylic acid has been recently shown to reduce abiotic stress by Yuan, S. et al., “Role of Salicylic Acid in Plant Abiotic Stress,” Z. Naturforsch. 63c, 313-20, 2008.

In some embodiments, biostimulants such as amino acids that can be used include glycine betaine, aminobutyric acid, seaweed extracts, amino acids of plant, animal and the like.

In some embodiments, the composition can include glycine betaine and salicylic acid, for which abiotic stress reduction was recently demonstrated by Park, E. J. et al., “Exogenous Application of Glycinebetaine Increases Chilling Tolerance in Tomato Plants,” Plant Cell Physiol. 47(6), 706-14, 2006).

In some embodiments, the composition can include terpenes, which have been regularly used in commercial products such as SCREEN DUO.

In some embodiments of the invention, the composition can comprise kaolin and/or calcium carbonate, and/or combinations thereof.

In some embodiments, the composition can comprise a vegetable oil and/or a phospholipid. In some embodiments, the vegetable oil can be soy oil. In some embodiments, the composition can comprise lecithin, for example, as soy lecithin which comprises both soy oil and phospholipids.

In some embodiments, a method of increasing tolerance to abiotic stress and/or reducing the effect of abiotic stress on a plant or part thereof comprises contacting the plant or part thereof with a first agent comprising an effective amount of one or more of ONA, AA, or esters or salts thereof, wherein an effective amount of the first agent is provided in a concentration in water between about 1×10⁻¹M about 1×10⁻⁹M. In some embodiments, an effective amount of a ONA or derivative thereof has a concentration between about 1×10⁻¹ M to about 1×10⁻⁸M, between about 1×10⁻²M to about 1×10⁻⁵M, between about 1×10⁻³M to about 1×10⁻⁴M, between about 1×10⁻³M to about 1×10⁻⁵M, between about 1×10⁻³ M to about 1×10⁻⁸ M, between about 1×10⁻⁴ M to about 1×10⁻⁸ M, and so forth. In other embodiments, an effective amount of a ONA or derivative thereof is provided in a concentration of approximately 10⁻¹ M, 10⁻² M, 10⁻³ M, 10⁻⁴ M, 10⁻⁵ M, 10⁻⁶ M, 10⁻⁷ M, 10⁻⁸ M, 10⁻⁹ M, and so forth.

In some embodiments, an effective amount of the first agent is an application of between about 0.00001 and about 1000 g/ha. In some embodiments, an effective amount is between about 0.0001 and about 750 g/ha, between about 0.001 and about 500 g/ha, between about 0.005 and about 250 g/ha, between about 0.01 and about 100 g/ha, between about 0.5 and about 50 g/ha, or between about 1 and about 25 g/ha. In some embodiments, an effective amount of the first agent is about 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, etc. g/ha.

In some embodiments, the composition can comprise from 0.1% to 99.9% by weight of any one of the first, second, or third agents. In other embodiments, the composition can comprise from 1% to 99%, 5% to 95%, 5% to 80%, 10% to 75% by weight of an agent, and so forth.

The application frequency or frequency of contact with the plant or portion thereof with a composition disclosed herein can be as frequent as necessary to impart the desired effect of increasing tolerance, and/or reducing the impact of abiotic stress. For example, the composition may be contacted with the plant or portion thereof one, two, three, four, five, six, seven or more times a day; one, two, three, four, five, six, seven, eight, nine, ten or more times per week; one, two, three, four, five, six, seven, eight, nine, ten or more times a month, and/or one, two, three, four, five, six, seven, eight, nine, ten or more times a year; as needed for increased tolerance to abiotic stresses.

In some embodiments of the present invention, the compositions of the present invention are in contact with the plant or part thereof from 1-10 times per season, from 1-11 times per season, 1-12 times per season, from 1-13 times per season, from 1-14 times per season, from 1-15 times per season, and so forth. In some embodiments, the number of days between applications, that is, the frequency of contact with the compositions of this invention with a plant or part thereof is from 1-100 days, 1-95 days, 1-90 days, 1-85 days, 1-80 days, 1-75 days, 1-70 days, 1-65 days, 1-60 days, 1-55 days, 1-50 days, 1-45 days, 1-40 days, 1-35 days, 1-30 days, 1-25 days, 1-20 days, 1-15 days, 1-10 days, 1-5 days, and the like. In other embodiments of the present invention, the number of days between the application of the compositions of the present invention to the plant or portion thereof, can be 1 day, 3 days, 4 days, 7 days, 10 days, 13 days, 15 days, 18 days, 20 days, 25 days, 28 days, 30 days, 32 days, 35 days, 38 days, 40 days, 45 days, and so forth. One of ordinary skill in the art can recognize that the treatment concentrations, amounts, intervals and number can vary depending on the type of plant/crop and the growing conditions experienced by the plant/crop. One of ordinary skill in the art would also recognize based upon the disclosure provided herein, that a composition of this invention may be effective for increasing abiotic stress tolerance and/or reducing the result of abiotic stress in a plant or part thereof, regardless of whether the initial application is applied to the plant before, during, and/or after the initiation of exposure to abiotic stress(es).

Compositions comprising ONA and/or derivatives thereof, comprising additional active components can also comprise an additional amount of each active ingredient from about 0.00001 g to about 1000 g of active ingredient per hectare. In some embodiments, each additional active ingredient can be applied at an application rate from about 0.0001 g to about 750 g of active ingredient per hectare, from about 0.001 g to about 500 g of active ingredient per hectare, from about 0.005 g to about 250 g of active ingredient per hectare, from about 0.01 g to about 100 g of active ingredient per hectare, from about 0.5 g to about 50 g of active ingredient per hectare or about 1 g to about 25 g of active ingredient per hectare. In some particular descriptions, the amount of each additional active ingredient may be 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, and the like, grams of active ingredient per hectare.

In some embodiments, compositions can comprise a second agent comprising, for example, kaolin or other sunblock. The second agent can be applied in an amount ranging from about 5 kg/ha to about 100 kg/ha. In some embodiments, the amount of second agent can be applied at an amount between about 5 kg/ha to about 100 kg/ha, about 5 kg/ha to about 10 kg/ha, about 5 kg/ha to about 15 kg/ha, about 5 kg/ha to about 20 kg/ha, about 5 kg/ha to about 30 kg/ha, about 5 kg/ha to about 40 kg/ha, about 5 kg/ha to about 50 kg ha, about 5 kg/ha to about 60 kg/ha, about 5 kg/ha to about 70 kg/ha, about 5 kg/ha to about 80 kg/ha, about 5 kg/ha to about 90 kg/ha, about 15 kg/ha to about 30 kg/ha, about 15 kg/ha to about 40 kg ha, about 15 kg/ha to about 50 kg/ha, about 15 kg/ha to about 60 kg/ha, about 15 kg/ha to about 80 kg/ha, about 15 kg/ha to about 90 kg/ha, about 15 kg/ha to about 100 kg/ha, about 20 kg/ha to about 50 kg/ha, about 20 kg/ha to about 80 kg/ha, about 20 kg/ha to about 100 kg/ha, about 40 kg/ha to about 80 kg/ha, about 40 kg/ha to about 100 kg/ha, about 50 kg/ha to about 80 kg/ha, about 50 kg/ha to about 100 kg/ha, about 75 kg/ha to about 100 kg/ha.

As discussed above, the compositions can comprise a first agent and a second agent. Alternatively, the first agent and second agent can be applied as separate formulations. Thus, a second agent comprising kaolin and/or calcium carbonate, and the like, or combinations thereof, can be applied in combination with the first agent or in a sequential application before or after the first agent.

As is shown herein, the surface of the plant and part thereof and includes plant parts that are above and below ground. In some particular teachings of this invention, the composition is contacted with the ground, being applied to the surface of the plant or plant part, which composition is then absorbed by the plant. Thus, a plant or plant part in the present invention includes, but is not limited to fruits, whole plant, leaves, stems, buds, inflorescences, flowers and parts thereof, stems, seeds, roots, rootstocks, and combinations thereof. When referring to a plant herein, all stages of development from seed or plant nursery propagation part, to maturity are included. Therefore, in some embodiments, the plant is a seed. In some embodiments, the plant is a nursery plant. In some embodiments, the plant can bear flowers and fruits (i.e., the plant reproduces sexually).

In some embodiments, a plant can be contacted with the compositions of the present invention in all stages of development. The stage or stages of plant development during which the compositions of the present invention are applied to the plant or plant part depends on the plant species, plant part, and the stress condition to which the plant or portion thereof is exposed. In some embodiments of the invention, the development stage in which a plant is contacted with the compositions of the invention is from petal fall to harvest.

The methods of the present invention are useful for any type of plant or part thereof exposed to an abiotic stress. Thus plants include, but are not limited to, gymnosperms, angiosperms (monocotyledonous and dicotyledonous plants), ferns, bryophytes, and combinations thereof. Specific nonlimiting examples of a plant or part thereof of the present invention include the following types of plants; woody, herbaceous, horticultural, agricultural, forestry, nursery, ornamental plant species, species of useful plants in the production of biofuels and combinations thereof.

In other embodiments of the invention, the term plant or part thereof includes but is not limited to, apples, tomatoes, pears, peppers, beans (e.g., green and dry), cucurbits (for example, pumpkin, cucumber, melon, watermelon and the like), fruits of papaya, mango, pineapple, avocado, stone fruit (e.g., plum, cherry, peach, apricot, nectarine, and the like), grapes (wine and table), strawberries, raspberries, blueberries, mango, gooseberry, banana, fig, citrus (for example, clementines, kumquat, orange, grapefruit, tangerine, lemon, lime, and the like), nuts (e.g., hazelnuts, pistachios, walnuts, macadamia nuts, almonds, pecans, and the like), litchi, soybeans, corn, sugar cane, peanuts, cotton, canola oil, sunflower, canola, alfalfa, snuff, sugar beet, potatoes, peas, carrots, cereals (e.g., wheat, rice, barley, rye, sorghum, oats, triticale, and the like), quinoa, lettuce, roses, tulips, violets, basil, palm, elm, ash, oak, maple, fir, cedar, pine, birch, cypress, coffee.

Thus, in some embodiments of the present invention, the plant or part thereof is tomato. In other embodiments, the plant or part thereof is a citrus tree. In other embodiments, the plant or part thereof is an apple tree. In further embodiments, the plant or part thereof are stonefruit. In other embodiments, the plant or part thereof or is a grape.

It is to be understood that while the invention has been described in conjunction with the preferred specific embodiments thereof, that the description above as well as the examples that follow are intended to illustrate and not limit the scope of the invention. The practice of the present invention will employ, unless otherwise indicated, conventional techniques of organic chemistry, pharmaceutical chemistry, immunochemistry, biochemistry and the like, which are within the skill of the art. Other aspects, advantages and modifications within the scope of the invention will be apparent to those skilled in the art to which the invention pertains. Such techniques are explained fully in the literature.

### Examples

### Example 1

### Field Trial Protocols

Field trials were conducted in commercial fields and orchards in Chile during the 2011-12 and 2012-13 growing seasons. The results were evaluated by measuring specific fruit parameters affected by abiotic stress including fruit diameter, fruit number, and amount of damage from heat or sunburn. The plants evaluated were apples and tomatoes. The plants in the trials received a conventional application of pesticides, under normal application conditions. The heat and light stress were considered important from the beginning of fruit development. High temperatures ranged between 30-35° C. ambient temperature measured by conventional methods in the shade from December to harvest.

The treatments included (1) no product against abiotic stress; (2) SUNCROPS (kaolin); (3) SUNCROPS PLUS (kaolin and azalaic acid); (4) ONA; (5) SUNCROPS and ONA; (6) SUNCROPS PLUS and ONA; (7) SCREEN DUO (kaolin and salicylates) and (8) ECLIPSE™. Foliage and fruit were evaluated before and after treatments at regular intervals for signs of phytotoxicity. No phytotoxicity was observed in the foliage or fruits with the formulations tested in any trials. Furthermore, no signs of uncontrolled disease incidence was detected.

The treatments were applied to plants or plant parts together with water as presented in Table 1. SUNCROPS, SUNCROPS PLUS, SCREEN DUO, and ECLIPSE are commercial treatments which are used in the management of abiotic stress. Kaolins and calcium carbonates reduce stress by reflecting the ultraviolet, visible and infrared rays, reducing the impact of excessive heat and light in photosynthesis and other essential plant cellular processes. The dicarboxylic acids, such as the azalaic acid in SUNCROPS PLUS, physiologically act by interacting on lipo-oxygenation processes and production of reactive oxygen species. (Greenberg et al. “The lipid whisker model of the structure of oxidized cell membranes.” J. Biol. Chem. 283, 2385-96, 2008)

TABLE 1
Treatments and dosage in field trials

| Treatment | Dosage |
|---|---|
| SUNCROPS | 1.25 kg/100 L water (12.5 kg/ha) |
| SUNCROPS PLUS | 1.25 kg/100 L water (12.5 kg/ha) |
| ONA | 8-10 g/ha |
| SUNCROPS + ONA | 12.5 kg/ha + 8-10 g/ha |
| SUNCROPS PLUS + ONA | 12.5 kg/ha + 8-10 g/ha |
| SCREEN DUO | 1.25 kg/100 L water (12.5 kg/ha) |
| ECLIPSE | 2.0 L/100 L water |

The apple trees received six applications of each formulation at the dosages indicated in the “Dosage” column of Table 1. Tomato plants received biweekly treatments from fruit formation to fruit harvest (a total of 6 applications).

The different stages of fruit development correspond to (1) cell division (2) pit hardening (stone fruits only) (3) cell expansion and (4) fruit ripening. The start of the tests was done during the cell division phase. This phase corresponds to the period with increased susceptibility to damage from high temperatures, and can be correlated with increase in fruits having reduced size and decrease in the number of fruits per plant as a consequence of the abiotic stress due to high temperatures.

Treatment with ONA alone or in combination with SUNCROPS and SUNCROPS PLUS was compared with standard treatments for managing heat, light and water stress which include SCREEN DUO, SUNCROPS, SUNCROPS PLUS and ECLIPSE (see Table 1).

### Example 2

### Apple Trees

Early season heat, light and/or water stress can prevent cell division that occurs during phase (1) of the development of apple fruits.

Testing with apples was conducted in Rancagua, Sixth Region; Chile. The tree fruit load was standardized at a value of about 220 fruits per tree; ±3%, thus eliminating the variability generated by different loads of fruit on the trees. To assess damage from sunburn related to heat and water stress, 100% of the apples were harvested from the tree in each test unit and were classified according to the following scheme shown in Table 2.

Table 2. Classification scheme based on visual evaluation of the fruit
0 No visible presence of sunburn
1 Presence of slight yellowing of the skin (<7% of the surface of the fruit); exportable commercial fruit.
2 Presence of strong yellowing of the skin (>7% of the surface of the fruit); exportable commercial fruit.
3 Presence of moderate sunburn skin, no commercial fruit, suitable only for juice or related industry.
4 Presence of significant sunburn skin, no harvestable fruit unmarketable.

The data show that ONA alone or in combination with kaolin (SUNCROPS) or with kaolin and dicarboxylic acids (SUNCROPS PLUS) was more effective than commercial treatments commonly used in the protection of fruit at cell division stage. The variables measured were: fruit diameter (mm), percentage of sunburn (number of fruits belonging to grades 1 or 2), size of the fruit (measured as weight in grams). The total fruit yield of the tree and the commercial yield (amount of commercial grade fruits, grades 1 or 2) was also measured. Results are shown in Table 3.

TABLE 3
Summary of field test data in apples

| | | | Percent | | | |
|---|---|---|---|---|---|---|
| | | Fruit | fruit of | | Yield | Yield |
| | | diameter | grades | Size | total | commercial |
| | Dosage | (mm) | 1 or 2 | (g/apple) | (kg/tree) | (kg/tree) |
| Untreated | | 38.11 | 76.81 | 135 | 45.1 | 37.1 |
| SUNCROPS | 12.5 kg/ha | 39.23 | 86.40 | 144 | 48.4 | 44.2 |
| SUNCROPS | 12.5 kg/ha | 40.58 | 88.73 | 148 | 55.6 | 50.2 |
| PLUS | | | | | | |
| ONA | 8-10 g/ha | 40.63 | 88.25 | 146 | 53.9 | 49.7 |
| SUNCROPS + | 12.5 kg/ha + | 41.70 | 89.74 | 150 | 52.8 | 51.1 |
| ONA | 8-10 g/ha | | | | | |
| SUNCROPS | 12.5 kg/ha + | 42.99 | 91.32 | 154 | 59.4 | 55.2 |
| PLUS + ONA | 8-10 g/ha | | | | | |
| SCREEN DUO | 12.5 kg/ha | 38.53 | 84.73 | 141 | 47.9 | 43.8 |
| ECLIPSE | 2 L/100 L water | 38.71 | 84.67 | 139 | 47.7 | 42.3 |
| LSD 0.05* | | 1.12 | 1.35 | 2.60 | 2.43 | 3.31 |

*Least Significant Difference at 95% confidence in analysis of variance

### Example 3

### Tomatoes

In tomato plants, abiotic stress generates significant yield losses starting at temperatures of 29° C. in periods of 3-5 hours and increase as the season progresses. Furthermore, once the fruit has developed, the fruit is more susceptible to damage from heat and light, which is expressed as sunburn. The sunburn damage is very severe from the period of greatest susceptibility (once the fruit has developed) until the beginning of the color change in the fruits from yellow to green and red.

The study was conducted on tomatoes in a commercial growing field in Botalcura, Talca, Chile.

Tomatoes were treated with ONA alone or in combination with SUNCROPS and SUNCROPS PLUS and were compared with standard treatments for managing heat, light and water stress including SCREEN DUO, SUNCROPS, SUNCROPS PLUS, and ECLIPSE.

The yield and sunburn were evaluated as described in Table 4 below. For each two meters plot, plants were harvested during six test runs. The fruit were first evaluated visually: fruits with red color as adequate for industrial processing, fruits with green color as inadequate and inappropriate for industrial processing and fruits damaged by the sun as disposable. The fruits harvested were classified in these three categories, then separated, and weighed.

ONA applied alone or in combination with kaolin (SUNCROPS) or kaolin and dicarboxylic acids (SUNCROPS PLUS) outperformed other commercial treatments when compared with commercial treatments for the management of heat, light and water stress, including the use of kaolin and salicylate (SCREEN DUO), kaolin (SUNCROPS), kaolin and dicarboxylic acids (SUNCROPS PLUS) and calcium carbonate (ECLIPSE). The test evaluated yields and the amounts (tons per hectare) of red fruits and burned fruits for each of the different treatments. Results are shown in Table 4.

TABLE 4
Summary of field trials data for Tomato production

| | | | Yield | Yield | Yield | Soluble |
|---|---|---|---|---|---|---|
| | | Sunburned | Red fruit | Sunburn | total | solids |
| | Dosage | Fruit | (Ton/ha) | (Ton/ha) | (Ton/ha) | °Brix |
| Untreated | | 43 | 111.7 | 16.8 | 128.5 | 4.5 |
| SUNCROPS | 12.5 kg/ha | 31 | 128.2 | 14.1 | 142.3 | 5.9 |
| SUNCROPS | 12.5 kg/ha | 27 | 133.8 | 11.8 | 145.6 | 6.5 |
| PLUS | | | | | | |
| ONA | 10 g/ha | 26.8 | 132.4 | 12.2 | 144.6 | 6.4 |
| SUNCROPS + | 12.5 kg/ha + | 25.4 | 138.6 | 11.3 | 149.9 | 6.6 |
| ONA | 10 g/ha | | | | | |
| SUNCROPS | 12.5 kg/ha + | 22.1 | 143.9 | 9.9 | 153.8 | 6.9 |
| PLUS + ONA | 10 g/ha | | | | | |
| SCREEN DUO | 12.5 kg/ha | 31.7 | 125.3 | 14.4 | 139.7 | 6.0 |
| ECLIPSE | 8 L/100 L water | 32.2 | 120.6 | 16.2 | 136.8 | 5.5 |
| LSD 0.05* | | 2.33 | 1.88 | 1.2 | 2.1 | 0.3 |

*Least Significant Difference at 95% confidence in analysis of variance

What is claimed is:

1. A composition for use in agriculture, comprising
a first agent and a second agent;
wherein the first agent comprises one or more of 9-oxononanoic acid, arachidonic acid, or a salt or ester thereof, and
wherein the second agent is operable as a sunblock.

2. The composition of claim 1, wherein the first agent further comprises one or more of pipecolic acid, a dicarboxylic acid, salicylic acid or a salt or ester thereof.

3. The composition of claim 1, wherein the composition is in powder form.

4. The composition of claim 1, wherein the second agent comprises one or more of silica, silica gels, silicates, talc, kaolin, limestone, lime, chalk, clay, bentonite, calcite, corn starch powder, dolomite, diatomaceous earth, calcium sulfate, magnesium sulfate, magnesium oxide, ground plastics, resins, and waxes, products of vegetable origin, such as cereal flour, tree bark meal, wood meal and nutshell meal, or cellulose powder.

5. The composition of claim 1, further comprising a third agent, wherein the third agent comprises one or more of a fertilizer, biostimulant, plant nutrient, plant micronutrient, amino acid, plant hormones and hormone-like compound, pesticide, fungicide, insecticide, nematicide, stearic acid, vegetable oil, or phospholipid.

6. The composition of claim 5, wherein the third agent comprises a plant hormone, wherein the plant hormone comprises an auxin, cytokinin, abscisic acid, gibberellin, ethylene, or salicylic acid.

7. The composition of claim 5, wherein the third agent comprises a biostimulant, wherein the biostimulant comprises glycine betaine, aminobutyric acid, or seaweed extract.

8. A method for treating a plant comprising
contacting a plant or a part of a plant with a first agent, the first agent comprising one or more of 9-oxononanoic acid, arachidonic acid, or a salt or ester thereof;
wherein the amount of the first agent is effective to increase tolerance to abiotic stress on the plant or to reduce a consequence of abiotic stress on the plant.

9. The method of claim 8, wherein the method further comprises contacting the plant or the part of a plant with a second agent, wherein the second agent is operable as a sunblock.

10. The method of claim 9, wherein the second agent comprises kaolin or calcium carbonate or a combination thereof.

11. The method of claim 8, wherein the first agent further comprises one or more of pipecolic acid, a dicarboxylic acid, salicylic acid or a salt or ester thereof.

12. The method of claim 8, wherein the method further comprises contacting the plant or the part of a plant with a third agent, wherein the third agent comprises one or more of a fertilizer, plant nutrient, biostimulant, micronutrient, amino acid, plant hormone, pesticide, fungicide, insecticide, nematicide, stearic acid, vegetable oil, or phospholipid.

13. The method of claim 8, wherein the contacting the plant or the part of a plant comprises spraying, dusting, sprinkling, scattering, fogging, dipping, injecting in the soil, soil incorporation, pouring, coating, seed treatment, soil treatment, or any combination thereof.

14. The method of claim 8, wherein the plant comprises an herbaceous plant, a horticultural plant, a tree, a perennial plant, an annual plant, a biannual plant, a vegetable, an ornamental plant, plants grown for industrial feedstock, or any combination thereof.

15. The method of claim 8, wherein the plant comprises apple, tomato, pear, pepper, green beans, dry bean, pumpkin, cucumber, melon, watermelon, melon, papaya, mango, pineapple, avocado, plum, cherry, peach, apricot, nectarine, grape, strawberry, raspberry, blueberry, mango, gooseberry, banana, fig, clementine, kumquat, orange, grapefruit, mandarin, tangerine, lemon, lime, hazelnut, pistachio nut, macadamia nuts, almonds, pecans, litchi, soybeans, corn, sugar cane, peanuts, cotton, canola oil, rapeseed, alfalfa, snuff, tomato, sugar beet, potatoes, peas, carrots, wheat, rice, barley, rye, sorghum, oats, triticale, quinoa, sunflower, lettuce, roses, tulips, violets, basil, oil palm, elm, ash, oak, maple, spruce, fir, cedar, pine, birch, cypress, coffee, or any combination thereof.

16. The method of claim 8, wherein the abiotic stress comprises low temperatures, freezing, heat, high temperatures, drought, salinity, high intensity light, ozone or any combination thereof.

17. The method of claim 8, wherein the effective amount of 9-oxononanoic acid, arachidonic acid, or esters or salts thereof is an amount between about 0.00001 and about 1000 g/ha.

18. The method of claim 17, wherein the effective amount of 9-oxononanoic acid, arachidonic acid, or esters or salts thereof is an amount between about 1 and about 25 g/ha.

19. The method of claim 8, wherein the frequency of the contacting is between about one time per month, to about one time per day.

20. A method for treating a plant comprising
contacting a plant or a part of a plant with the composition of claim 1, wherein the amount of the first agent is effective to increase tolerance to abiotic stress on the plant or to reduce a consequence of abiotic stress on the plant.
